(19) United States
(12) Patent Application Publication
(10) Pub. No.: US 2015/0130101 A1
(43) Pub. Date: May 14, 2015

(54) METHOD AND APPARATUS FOR FEEDING PRINT MATERIAL

(71) Applicant: John D. Fiegener, Marblehead, MA (US)

(72) Inventor: John D. Fiegener, Marblehead, MA (US)

(21) Appl. No.: 14/077,677

(22) Filed: Nov. 12, 2013

(51) Int. Cl. B29C 67/00

(52) U.S. Cl. CPC B29C 67/0062; B29C 67/0088; B29K 2105/251
USPC 264/40.4; 264/319; 425/375; 425/447; 425/169

(57) ABSTRACT

This invention relates to providing a printing assembly having a small hopper and a heating element disposed therein. The small hopper is configured to receive a plurality of pellets therein and feed the pellets to the heating element. The heating element melts the pellets to form a molten material for use in three dimensional printing. A large hopper may be provided to store a large amount of pellets. The large hopper may include a door which may be automatically abuttably opened by the printer assembly when a sensor indicates the pellets are below a particular threshold and the printer assembly is in need of additional pellets.

### BACKGROUND OF THE INVENTION

1. Technical Field

This invention relates to a method and apparatus for feeding print material. More particularly, this invention relates to forming a printing material on demand to facilitate printing a three dimensional object. Specifically, this invention relates to heating pellets inside a printer assembly into a molten material on demand to facilitate printing a three dimensional object with the molten material.

2. Background Information

Current three dimensional printers use a spool of specially formed filament as the source of printing material. As the three dimensional printer prints an object, the filament is unwound off the spool and fed through an extruder nozzle assembly. However, filament often breaks due to environmental conditions such as the ambient temperature of the room, the spooled nature of the filament itself, or the bends in the printing machine as the filament travels from the spool to the nozzle. Further, oftentimes three dimensional printers are left unattended while printing, sometimes overnight, as printing three dimensional objects is a time consuming process. At any point in the process, if a filament breaks the print is likely unsalvageable and must be discarded. In addition, three dimensional printers may not sense when a filament breaks. Thus, the printer may continue moving and “printing” the object without any material being expelled from the nozzle. This represents and enormous problem in the art, as much time and expenses are wasted when a filament breaks. Thus, there is a need in the art to eliminate the problems associated with spooled filaments. More particularly, there is a tremendous need in the art to eliminate breakage of printing filaments.

### BRIEF SUMMARY OF THE INVENTION

In one aspect, the invention may provide a method of three dimensional printing, the method comprising the steps of: delivering a plurality of pellets to a printer assembly; forming a pellet of the plurality of pellets into a molten material; and expelling the molten material from the printer assembly to facilitate printing a three dimensional object.

In another aspect, the invention may provide an apparatus adapted to receive a plurality of pellets, the apparatus comprising: a printer assembly, wherein the printer assembly includes a heating element and a nozzle, and wherein the printer assembly is adapted to heat the plurality of pellets therein and expel a molten material; a control system adapted to move the printer assembly and print a three dimensional object using the molten material expelled by the printer assembly; wherein the heating element heats the plurality of pellets to form the molten material; and wherein the printer assembly expels the molten material through the nozzle.

In another aspect, the invention may provide a method of producing a three dimensional object, the method comprising: disposing a plurality of pellets in a first hopper; directing the plurality of pellets towards a heating element; melting the plurality of pellets with the heating element to form a molten material; and using the molten material to produce the three dimensional object.

### BRIEF DESCRIPTION OF THE SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a perspective view of a printer of the present invention;

FIG. 2 is a similar view thereof showing a hopper of the printer separated from a base of the printer;

FIG. 3 is a perspective view of an under side of the hopper;

FIG. 4 is a top view of the base having a top wall removed;

FIG. 5 is a cross-sectional view taken along line 4-4 of FIG. 3;

FIG. 6 is an enlarged view of a printer assembly of the present invention;

FIG. 7 is a cross-sectional view similar to FIG. 5 showing the printer assembly moved in the direction of Arrow B;

FIG. 8 is an enlarged cross-sectional view of the printer assembly and the hopper showing pellets moving from the hopper to the printer assembly;

FIG. 9 is a similar view thereof showing the pellets being melted and extruded by the printer assembly;

FIG. 10 is a similar view thereof showing another embodiment of the printer assembly; and

FIG. 11 is a perspective view of another embodiment of the printer of the present invention.

Similar numbers refer to similar parts throughout the drawings.

### DETAILED DESCRIPTION OF THE INVENTION

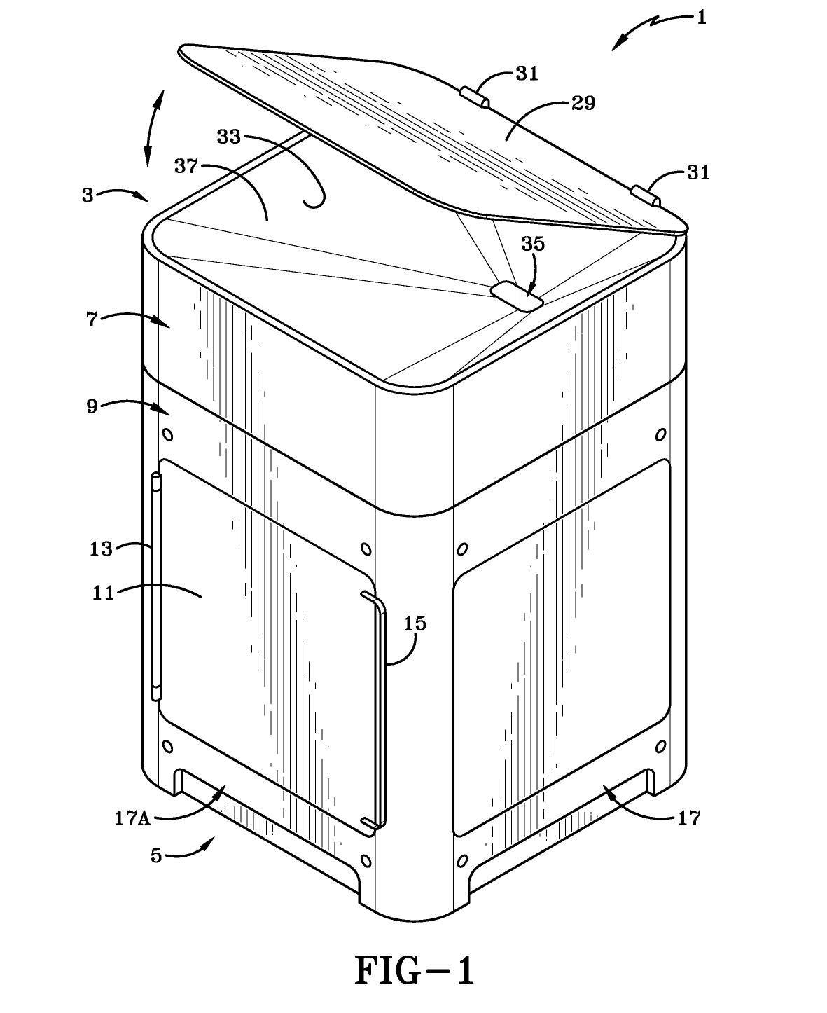

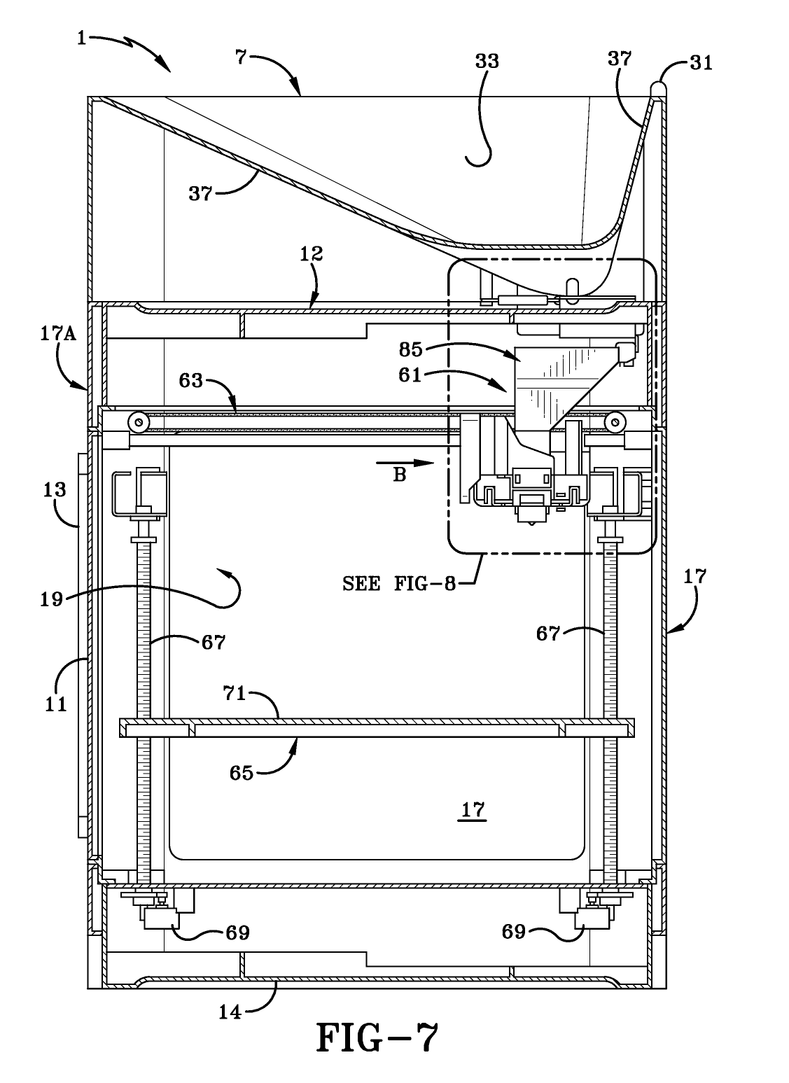

A method and apparatus for feeding print material is shown in FIGS. 1-11 and referred to generally herein as printer 1. Various non-novel features found in the prior art relating to three-dimensional or additive printing are not discussed herein. The reader will readily understand the fundamentals of printing are well within the prior art and readily understood by one familiar therewith.

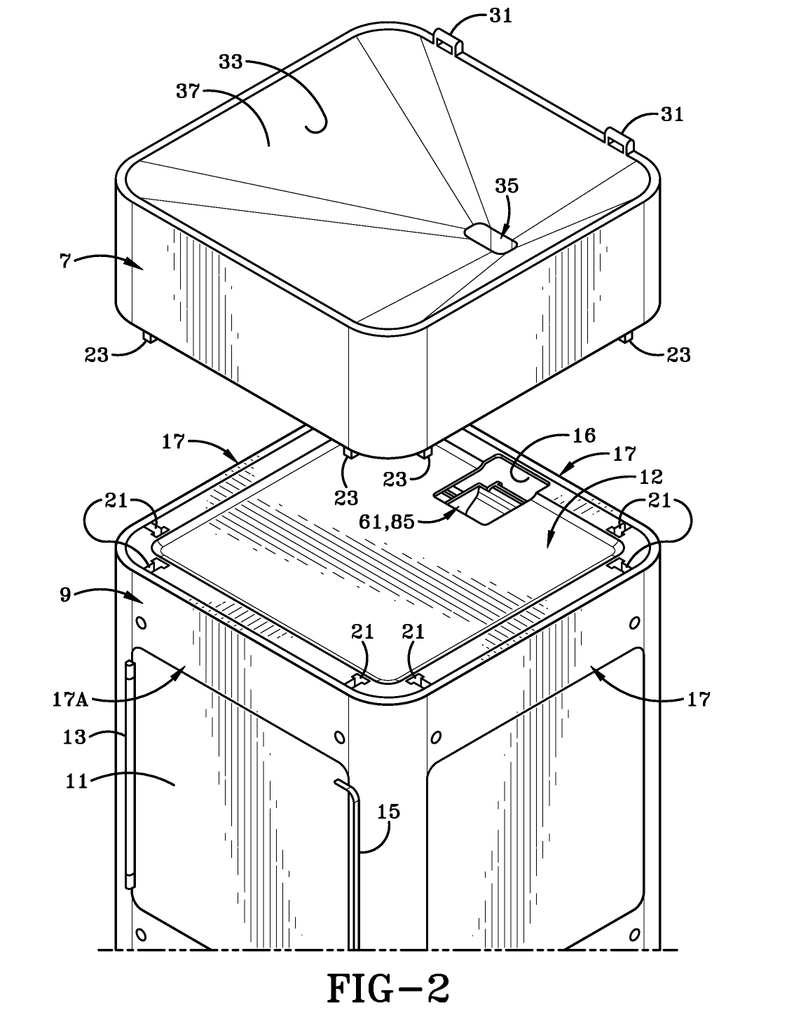

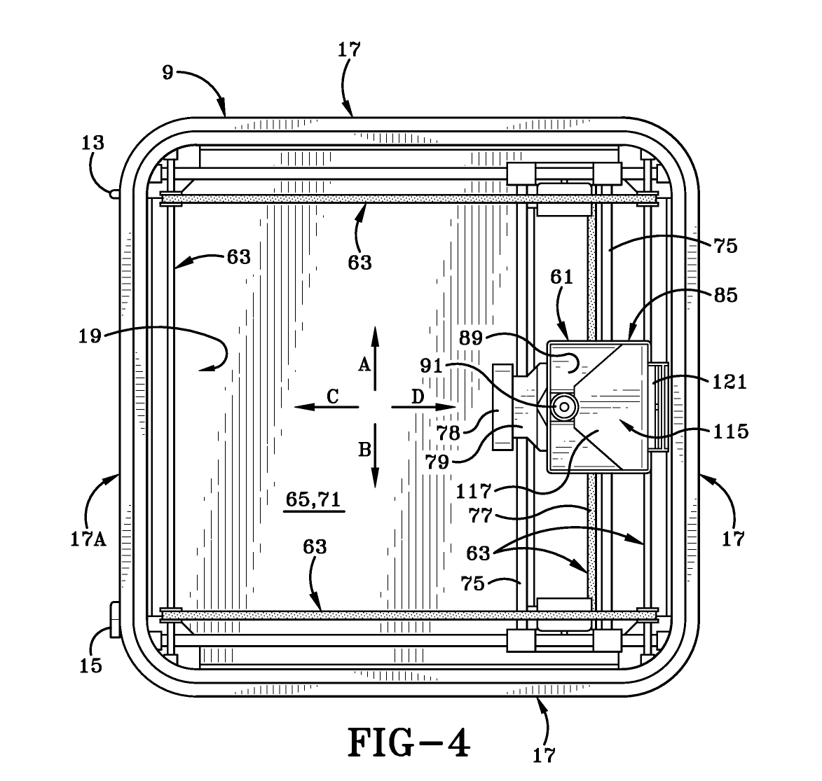

As shown in FIGS. 1, 2, and 4, printer 1 extends from a top area 3 to a bottom area 5 and is generally formed in an overall “box-like” shape. Printer 1 includes a first hopper 7, hereinafter referred to as large hopper 7, which is releasably connected with a base 9. Base 9 includes a top wall 12 (FIG. 2), a bottom wall 14 (FIG. 4), and four sidewalls 17 extending therebetween, with one sidewall 17A having a door 11 pivotable about a hinge 13 via a handle 15. Door 11 exposes an interior chamber 19 (FIG. 4) where an object may be printed by printer 1. As shown in FIG. 2, top wall 12 defines a plurality of recesses 21 sized to receive a matching plurality of projections 23 extending from large hopper 7. Top wall 12 further defines an aperture 16 opening to interior chamber 19.

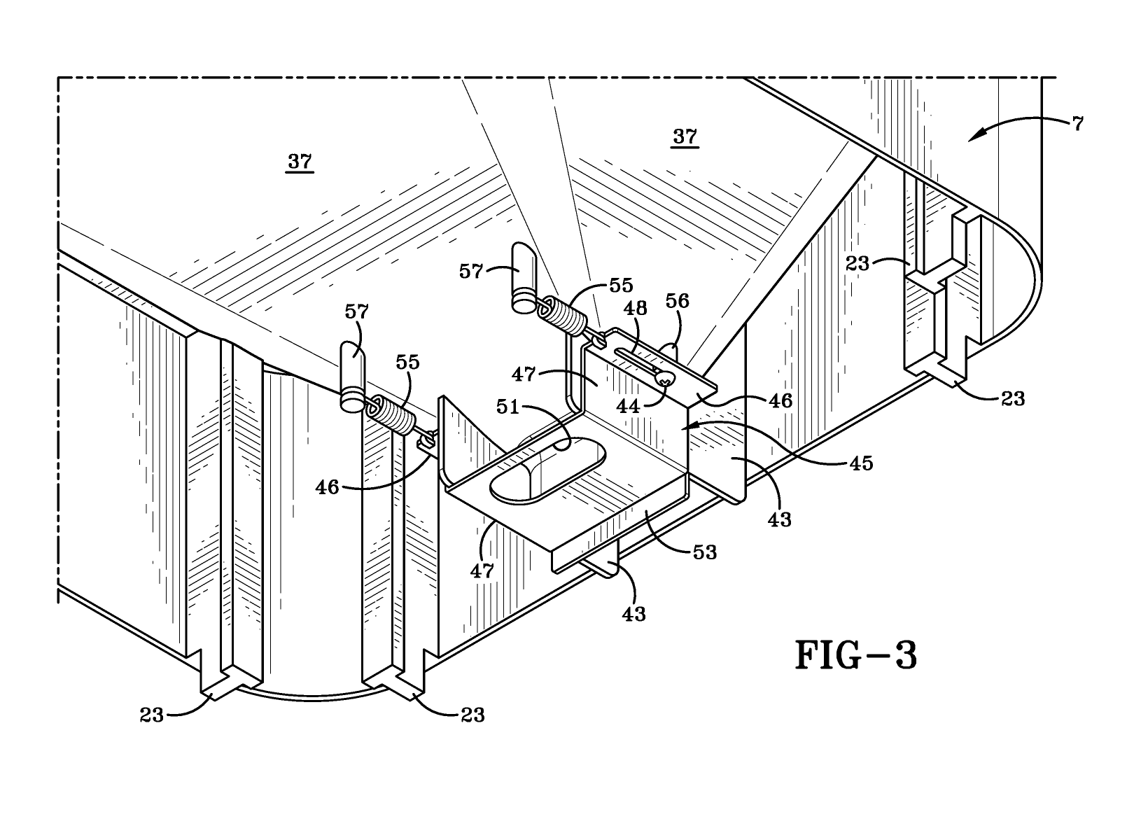

As shown in FIGS. 1-3, large hopper 7 is sized to complementarily and abuttably fit with base 9 and thus includes the same general cross-sectional shape as base 9. Large hopper 7 extends from a first end 25 to a second end 27. Proximate first end 25, large hopper 7 includes a lid 29 attached thereto by a pair of hinges 31. Lid 29 movably covers and uncovers a chamber 33 and a channel 35, both defined by a sloping wall 37. Channel 35 extends from a first end 39 generally disposed in chamber 33 to a second end 41 generally disposed between a pair of brace walls 43. As shown in FIG. 3, brace walls 43 are sized to receive a slider 45 having a pair of vertical walls 47 and a horizontal wall 49 extending therebetween. The pair of vertical walls 47 slidably abut the pair of brace walls 43 and slide thereupon. Extending outwardly from each vertical wall 47 is a slider fin 46 defining a slot 48 therein. A screw 44 extends through slot 48 and is received in a post 56 extending from sidewall 37. Slot 48 is oriented to allow slider 45 to slide about screw 44, with slot 48 acting as a track for slider 45 to move against.

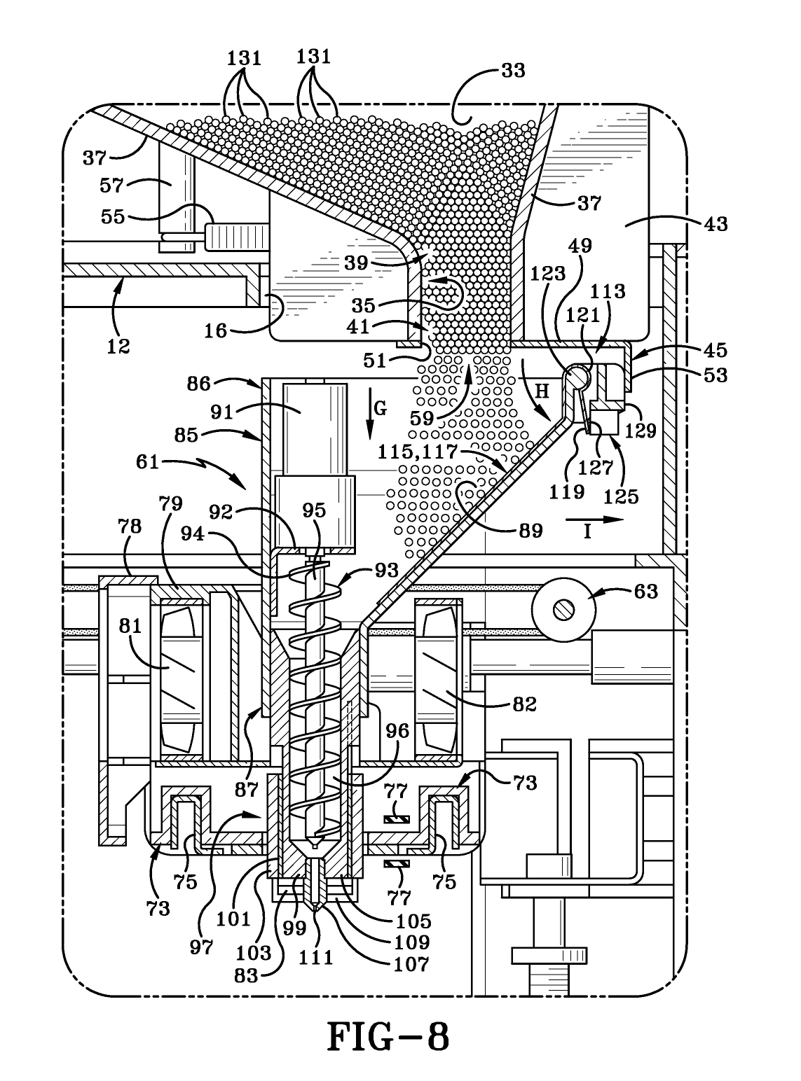

Horizontal wall 49 defines an aperture 51 sized to generally match the cross sectional shape of channel 35 (FIG. 8). Slider further includes cam plate 53 extending outwardly away from horizontal wall 49. A pair of springs 55 are connected at one end to slider 45 and at the other end to a corresponding peg 57 extending outwardly away from the underside of wall 37. While shown in FIG. 3 as extending from wall 37, pegs 57 may be connected or positioned in any way convenient for providing stable tension on springs 55.

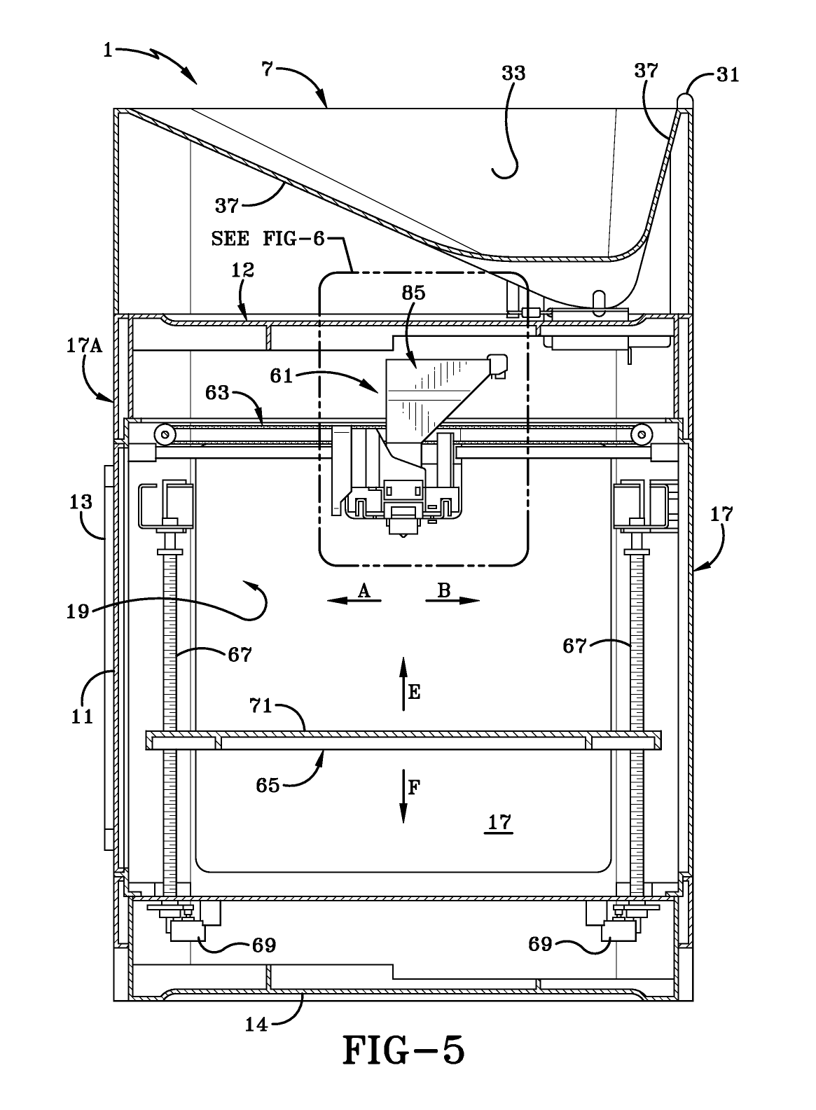

As shown in FIG. 5, slider 45 is configured to extend through aperture 16 when large hopper 7 is connected to base 9. Slider is further configured to slide between an open position (FIG. 8) and a closed position (FIG. 3). Slider 45 is biased to the closed position and in the direction of pegs 57 by way of springs 55. Slider 45 is prevented from sliding beyond the closed position in the direction of pegs 57 by way of slot 48 terminating and preventing further movement in the direction of pegs 37. Slider 45 moves from the closed position to the open position when cam plate 53 receives sufficient pressure to overcome the bias of springs 55. In the open position, aperture 51 aligns with second end 41 of channel 35 to create a channel 59 (FIG. 8). Channel 59 extends from chamber 33 through channel 35 and through aperture 51 and establishes fluid communication between chamber 33 and interior chamber 19. Channel 59 does not exist when slider 45 is in the closed position, as horizontal wall 49 moves to close channel 59 and terminate fluid communication between chamber 33 and interior chamber 19.

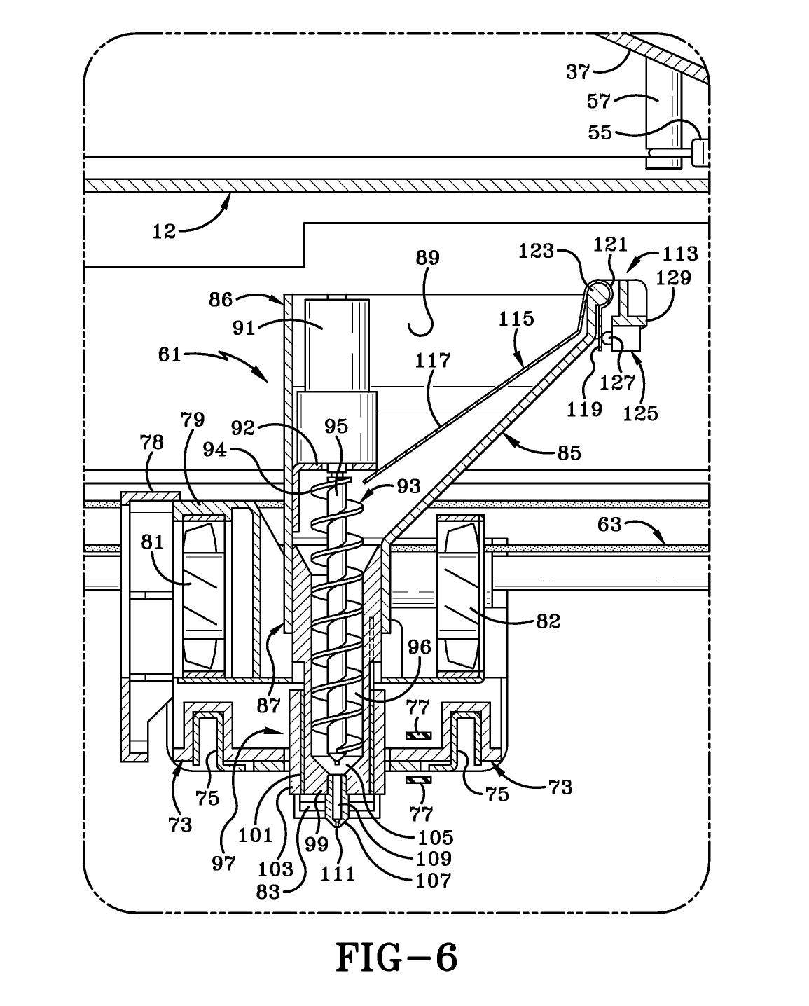

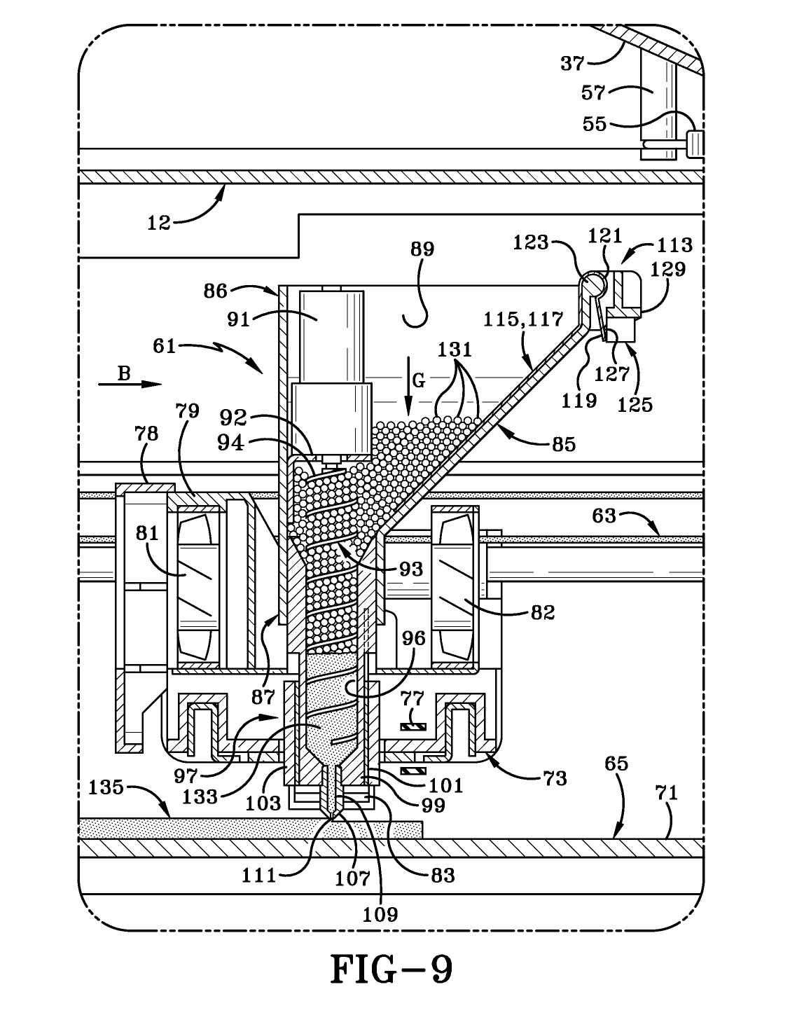

As shown in FIGS. 5 and 6, printer 1 further includes a printer assembly 61 disposed in chamber 19 and movable about an X-axis and a Y-axis therein in the directions of Arrows A, B, C, and D of FIG. 4. This movement is accomplished by way of a pulley assembly 63. Pulley assembly 63 includes all of the features recognizable to one familiar with the art, including tension rods, pulleys, belts, and motors. Inasmuch as pulley assembly 63 is well known in the prior art, a lengthy discussion of the features and elements therein is unnecessary. Printer assembly 61 and pulley assembly 63 are configured to work in conjunction with a plate 65 movable about a Z-axis in the directions of Arrows E and F of FIG. 5. Plate 65 is movable about the Z-axis by way of threaded rods 67 turned by motors 69 to move plate 65 up and down by way of the threads on rods 67. Printer assembly 61, pulley assembly 63, and plate 65 are all inner-connected by way of circuitry and logic controlled by a processor (not shown). The processor and logic are configured to move plate 65 in the Z-axis and move printer assembly 61 in the X-axis and Y-axis to additively print an object 135 onto a top surface 71 of plate 65, as shown in FIG. 9. Inasmuch as the system logic and operational methodologies of three-dimensional additive printing is known in the prior art, a lengthy discussion of the features and elements therein is unnecessary.

As shown in FIG. 6, printer assembly 61 includes a carriage 73 which rests on a pair of rails 75 and is coupled to a looped belt 77, which is driven by the pulley assembly 63. Printer assembly 61 further includes an inlet grill 78 proximate a baffle 79 resting on carriage 73, sized to house a fan 81 and permit the flow of air therethrough. Baffle 79 is coupled with a blower element 83 which is configured to direct air from fan 81 through printer assembly 61 in a particular direction to cool a printed object. Printer assembly 61 also includes a fan 82 coupled with baffle 79 and configured to direct air through printer assembly 61 to cool the parts therein.

Printer assembly 61 further includes a second hopper 85, hereinafter referred to as small hopper 85, having a first end 86 and a second end 87. Small hopper 85 defines an opening 89 proximate first end 86 and tapers towards second end 87. A motor 91 is disposed inside small hopper 85 and connected thereto by a support flange 92. Motor 91 is connected to an auger 93 having an auger flight 94 traversing a shaft 95. Motor 91 rotates shaft 95 which in turn rotates flight 94. Auger 93 is partially disposed in a melt chamber 96 defined by a heating assembly 97. Heating assembly 97 includes a first heating element 99 partially surrounded by a second heating element 101. Second heating element 101 is partially surrounded by a thermal coupling barrel 103 for use in sensing the surface temperature of second heating element 101. First heating element 99 defines a tapered section 105 of melt chamber 96 which tapers to a nozzle 107. Melt chamber 96 terminates at nozzle 107, which defines a channel 109 therein. Channel 109 extends through nozzle 107 from melt chamber 96 to an aperture 111 defined by nozzle 107. Aperture 111 acts as the opening of channel 109.

As shown in FIG. 6, printer assembly 61 further includes a sensor assembly 113. Sensor assembly 113 includes a level indicator 115 having a first portion 117, a second portion 119, and an arcuate pivot portion 121 disposed therebetween. First portion 117 is sized to extend into small hopper 85. Pivot portion 121 is sized to pivot about an arcuate flange 123 of small hopper 85. Second portion 119 is sized and positioned to actuate a sensor 125 by pressing a plunger switch 127 thereof when level indicator 115 is in a particular position. Sensor 125 is secured to a bracket 129 of printer assembly 61.

Printer 1 is configured to be used with a plurality, of pellets 131 (FIG. 8). Pellets 131 may be of any type of meltable, printable, and/or extrudable plastic or other type of material. This material is formed into pellets and used by printer 1 to form the extruded print material on demand and as needed. Pellets 131 may be injection molding pellets commonly used in injection molding systems and available commercially from injection molding equipment vendors. Injection molding pellets are readily available “off-the-shelf” and are typically priced approximately one tenth the price of three dimensional printer filament spools. Further, injection molding pellets are typically available in a variety of colors, sizes, and chemical composition. As such, a user of printer 1 may customize each print job with a different plurality of pellets in printer 1 which best suit the structural and aesthetic needs of the prospective objected to be printed.

Printer assembly 61 is configured to receive pellets 131 into small hopper 85 from large hopper 7 in the direction of Arrows G, as shown in FIG. 8. Pellets 131 enter small hopper 85 via first end 86 and opening 89 and abut and surround auger 93. As shown in FIG. 9, pellets 131 are driven downwardly towards tapered section 105 via auger flights 94 as auger 93 is turned by motor 91. The turning motion of auger 93 moves pellets 131 downwardly along and through heating assembly 97. During printing, heating assembly 97 is actuated to provide heat to melt chamber 96 which is transferred into pellets 131. More particularly, second heating element 101 receives an electrical current heating it and increasing thermal energy which is transferred into first heating element 99. First heating element 99 is configured to heat up evenly and transfers this thermal energy into pellets 131 as they move through melt chamber 96. This results in a melting of pellets 131 into a molten material 133 (FIG. 9). Thermocoupling barrel 133 reads the surface temperature of second heating element 101 and provides this information to the overall controlling unit for processor used in printer 1. This feedback is used to determine when to heat or cease heating of heating assembly 97. As pellets 131 melt into molten material 133, motor 91 continues to drive auger 93 to agitate pellets 131 and ensure an even and thorough heating. Auger 92 further presses both pellets 131 and molten material 133 towards nozzle 107. By the time pellets 131 reach nozzle 107, they have been melted by heating assembly 97 into molten material 133 and are in a sufficient viscosity to be printed via nozzle 107. As such, molten material 133 is expelled through channel 109 and out aperture 111 in accordance with the printing requirements.

In operation, printer 1 is initially provided free of pellets 131. A user approaches printer 1, lifts lid 29 of large hopper 7 about hinges 31 to reveal chamber 33. The user then fills chamber 33 with the plurality of pellets 131 which may have a particular color desirable to the user or may be comprised of injection molding pellets bought off-the-shelf. The user then closes lid 29 to seal chamber 33. Pellets 131 now populate chamber 33 and due to gravity tumble or slide down side wall 37 in the direction of channel 35. Pellets 131 fill channel 35, however, pellets 131 do not exit channel 35 due to the abutment of slider 45 which prevents pellets 131 from traveling beyond channel 35. At this stage, large hopper 7 is filled with pellets 131 and is in a ready state waiting for printer 1 to begin the printing process. Typically, the user will load a software program to initiate the printing process, typically by selecting menu options on a computer screen which drive the printing process of printer 1.

As shown in FIG. 6, level indicator 115 is in a first position which leaves plunger switch 127 undepressed by second portion 119. When plunger switch 127 is in the undepressed state, sensor 125 indicates to the overall software system that printer assembly 61 is in need of pellets 131. Upon such indication, printer assembly 61 is driven by pulley assembly 63 in the direction of Arrow B such that printer assembly 61 abuts cam plate 53. Printer assembly 61 moves cam plate 53 in the direction of Arrow B which slides slider 45 in the direction of Arrow B. This positions aperture 51 of horizontal wall 49 in alignment with channel 35 of large hopper 7. As shown in FIG. 8, by aligning aperture 51 with channel 35, channel 59 is formed and allows pellets 131 residing in large hopper 7 to flow through channel 35 and aperture 51 and fall into small hopper 85 of printer assembly 61 and in the direction of Arrows G. The weight of pellets 131 depresses level indicator 115, and in particular first portion 117. This moves pivot portion 121 over arcuate flange 23 and subsequently actuates second portion 119 to depress plunger switch 127 of sensor 125. The depression of plunger switch 127 initiates a software subroutine which actuates printer assembly 61 to move in the direction of Arrow A and away from cam plate 53. Inasmuch as slider 45 is spring loaded by springs 55 and biased in the direction of Arrow A, printer assembly 61 moving in the direction of Arrow A allows slider 45 to automatically move in the direction of Arrow A and close channel 59. By closing channel 59, pellets 131 may no longer exit large hopper assembly 7 and are contained therein until further need.

After small hopper 85 is sufficiently filled with pellets 131, the overall printing process of printer 1 may begin. Motor 91 is engaged to rotate auger 93 and drive pellets 131 downwardly in the direction of Arrow G. The weight of pellets 131 presses down on first portion 117 of level indicator 115 in the direction of Arrow H. This rotates pivot portion 121 about arcuate flange 123 and moves second portion 119 to depress plunger switch 127 in the direction of Arrow I. The depression of plunger switch 127 indicates to sensor 125 small hopper 85 has a sufficient amount of pellets 131 therein, as shown in FIG. 9.

As shaft 91 of auger 93 turns, auger flights 94 direct each pellet 131 downwardly through melt chamber 96. Within melt chamber 96, pellets 131 are melted by first heating element 99 and second heating element 101 and turned into molten material 133. The continuing pressure and movement of pellets 131 and molten material 133 along auger flights 94 press molten material 133 into tapered section 105 and further into nozzle 107. All the while, printer assembly 61 is moving in one or more of the X-axis, Y-axis, and Z-axis, to position nozzle 107 as desired and as required by the desired printing operation. As shown in FIG. 9, nozzle 107 extrudes or prints molten material 133 outwardly away therefrom where molten material 133 is expelled through aperture 111 to print object 135. Fan 81 blows cooling air outwardly away from blower 83 and onto object 135 to cool and solidify molten material 133 into object 135. As such, pellets 131 are formed into molten material 133 on demand and as needed by the overall printer 1 and extruded outwardly from nozzle 107 as required by the print job.

At any point during the printing process, if the plurality of pellets 131 in small hopper 85 fall below a particular preset threshold, level indicator 114 rises due to the removal of pressure thereupon by pellets 131. Level indicator 114 is connected with arcuate flange 123 such that when first portion 117 moves upwardly, second portion 119 presses into plunger switch 127 and depresses plunger switch 127 into sensor 125. The depression of plunger switch 127 actuates a subroutine configured to automatically acquire more pellets 131 from large hopper 7. In this scenario, printer assembly 61 moves to abut cam plate 53 and release pellets 131 from large hopper 7 in the same manner as discussed above with respect to the initial receipt of pellets 131. In this manner, printer 1 may print continuously and without any need for human intervention to ensure printer 1 is supplied with pellets 131 and overall supplied with print material, referred to herein as molten material 133.

One will readily recognize that printer 1 does not include a print filament as commonly known in the art and will not experience a broken filament or a broken printing stream as the printing stream of printer 1 is fluid and dynamically replenished during the print process. Further, one will also readily recognize that printer 1 includes an automatic mechanism for refilling small hopper 85 by way of sensor assembly 113 and large hopper 7. Large hopper 7 is sufficiently sized to provide chamber 33 having enough volume to contain a large enough supply of pellets 133 for completing any size print job capable of being printed by printer 1.

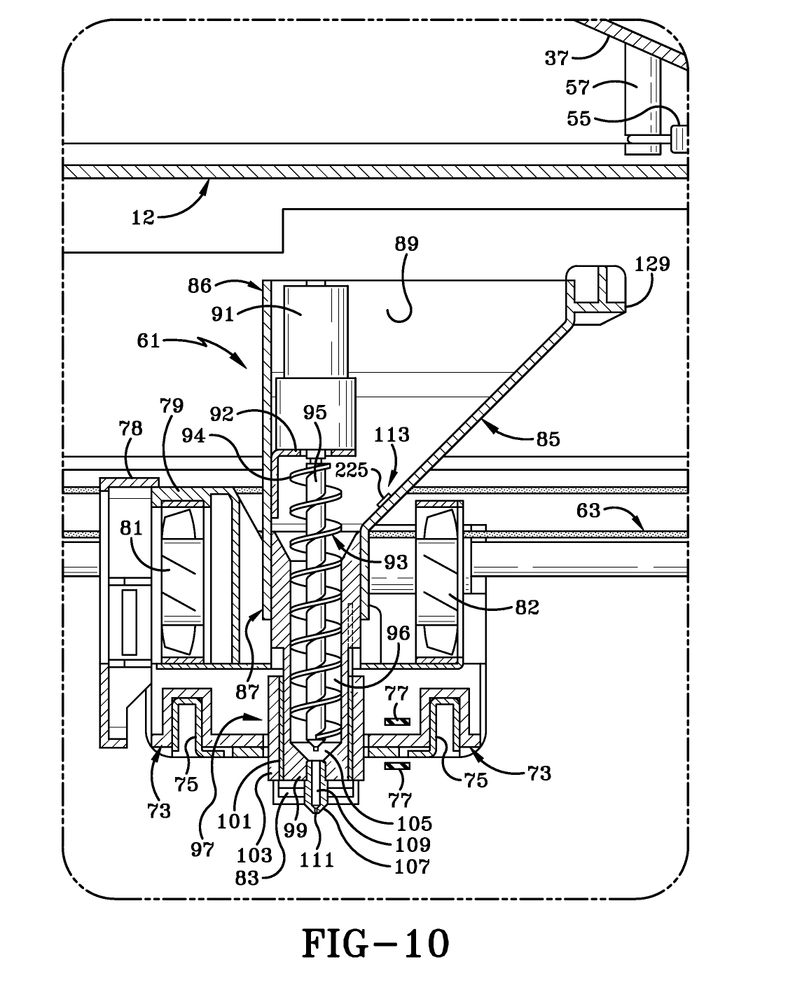

As shown in FIG. 10, sensor assembly 113 may incorporate a sensor 225 free of the plunger switch of the previous embodiment for another style of sensing device. As such, sensor 225 may be a light sensor or a pressure sensor for recognizing when pellets 131 have fallen below a particular threshold. At that time, sensor 225 alerts sensor assembly 113 whereby a software routine is actuated to automatically retrieve more pellets 131 in the methods previously discussed. Sensor 225 may alert sensor assembly 113 by way of a wireless communication link between two wireless modules. Further, sensor assembly 113 may alert the overall control unit or processor by way of a wireless communication link between two wireless modules, one residing proximate sensor assembly 113 and one residing proximate the control unit or processor. In this way, wired communication is not necessary and the tangling of communication wires as printer assembly 61 moves in the X-axis, Y-axis, and Z-axis is prevented.

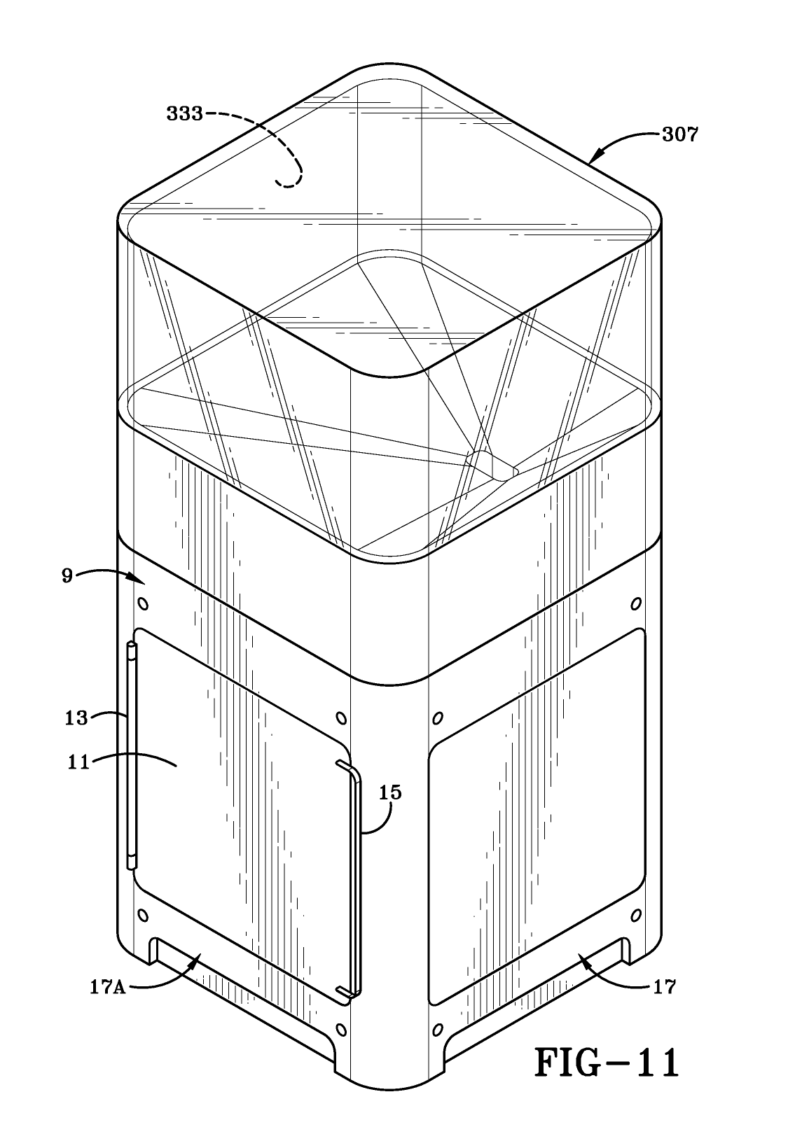

As shown in FIG. 11, large hopper 7 may be embodied by a large hopper 307 which includes a chamber 333 which is inaccessible by a user. Chamber 333 is sealed at the factory and provided or sold to a user in a sealed state for connection with base 9. As such, printer 1 may alternatively utilize large hopper 7 which is refillable by a user or large hopper 307 which is not refillable by a user. Printer 1 may be configured to receive either large hopper 7 or large hopper 307, or both.

“Logic,” “logic circuitry,” or “logic circuit,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

1. A method of three dimensional printing, the method comprising the steps of:
delivering a plurality of pellets to a printer assembly;
forming a pellet of the plurality of pellets into a molten material; and
expelling the molten material from the printer assembly to facilitate printing a three dimensional object.

2. The method of claim 1, further comprising the steps of:
heating the pellet; and
melting the pellet to form the molten material.

3. The method of claim 1, further comprising the step of:
sensing when an amount of the plurality of pellets in the printer assembly is below a threshold; and
actuating a process to receive additional pellets into the printer assembly.

4. The method of claim 3, further comprising the step of delivering the plurality of pellets from a first hopper into the printer assembly, wherein the first hopper includes an outlet aperture for providing the pellets therethrough.

5. The method of claim 4, further comprising the steps of:
opening a door proximate the first hopper to unobstruct the outlet aperture; and
allowing the plurality of pellets to fall through the unobstructed outlet aperture and into the printer assembly.

6. The method of claim 5, further comprising the steps of:
obstructing the outlet aperture with the door when the door is in a closed position;
unobstructing the outlet aperture with the door when the door is in an open position; and
moving the printer assembly to abuttably move the door from the closed position to the open position.

7. The method of claim 1, further comprising the step of rotating an auger of the printer assembly to agitate the plurality of pellets towards a heating element.

8. An apparatus adapted to receive a plurality of pellets, the apparatus comprising:
a printer assembly, wherein the printer assembly includes a heating element and a nozzle, and wherein the printer assembly is adapted to heat the plurality of pellets therein and expel a molten material;
a control system adapted to move the printer assembly and print a three dimensional object using the molten material expelled by the printer assembly;
wherein the heating element heats the plurality of pellets to form the molten material; and
wherein the printer assembly expels the molten material through the nozzle.

9. The apparatus of claim 8, further comprising a first hopper adapted to receive the plurality of pellets therein, and wherein the first hopper provides a portion of the plurality of pellets to the printer assembly.

10. The apparatus of claim 9, wherein the printer assembly further includes a second hopper, and wherein the second hopper receives the portion of the plurality of pellets from the first hopper.

11. The apparatus of claim 10, wherein the printer assembly further includes an auger disposed in the second hopper, and wherein the auger agitates the portion of the plurality of pellets towards the heating element and the nozzle.

12. The apparatus of claim 10, further comprising a sensor operably connected to the control system, and wherein the sensor determines when the portion of the plurality of pellets is below a threshold and alerts the control system.

13. The apparatus of claim 12, wherein the portion of the plurality of pellets is a first portion, and wherein the control system actuates a transfer of a second portion of the plurality of pellets from the first hopper to the second hopper when the sensor determines the first portion is below the threshold.

14. The apparatus of claim 13, further including a door disposed proximate the first hopper, and wherein the control system moves the printer assembly to abutably open the door to receive the second portion.

15. The apparatus of claim 12, further comprising a first wireless module operably connected to the control system and a second wireless module operably connected to the sensor, and wherein the sensor wirelessly communicates with the control system via the first wireless module and the second wireless module.

16. A method of producing a three dimensional object, the method comprising:
disposing a plurality of pellets in a first hopper;
directing the plurality of pellets towards a heating element;
melting the plurality of pellets with the heating element to form a molten material; and
using the molten material to produce the three dimensional object.

17. The method of claim 16, further comprising the step of rotating an auger to direct the plurality of pellets towards the heating element.

18. The method of claim 16, further comprising the step of opening an outlet aperture in a second hopper to transfer the plurality of pellets from the second hopper to the first hopper.

19. The method of claim 18, further comprising the providing injection molding pellets as the plurality of pellets.

20. The method of claim 16, further comprising the step of locating the first hopper and heating element within a movable printer assembly.
